(19) United States
(12) Patent Application Publication
(10) Pub. No.: US 2016/0272096 A1
(43) Pub. Date: Sep. 22, 2016

(54) SEAT PART, BACKREST AND VEHICLE SEAT

(71) Applicant: JOHNSON CONTROLS GMBH, Burscheid (DE)

(72) Inventors: Marcel Nagel, Witten (DE); Daniel Matysiak, Köln (DE); Marco Prüfer, Lindlar (DE); Michael Dilsen, Wassenberg (DE)

(21) Appl. No.: 15/034,610

(22) PCT Filed: Oct. 24, 2014
(86) PCT No.: PCT/EP2014/072886

§ 371 Date: May 5, 2016

(30) Foreign Application Priority Data
Nov. 8, 2013 (DE) 10 2013 222 720.5
Jan. 24, 2014 (DE) 10 2014 000 770.7

(51) Int. Cl. B60N 2/68; B60N 2/58

(52) U.S. Cl. CPC B60N 2/682; B60N 2/5816

(57) ABSTRACT

The invention relates to a seat part, in particular a backrest for a vehicle seat, which seat part comprises a seat part panel, a lining and a fastening groove for fastening the lining to the seat part panel, wherein the seat part further comprises a fastening means which is separately fastened to the seat part panel, and wherein said fastening means comprises the fastening groove.

### PRIOR ART

It is known from the prior art to construct backrests from a back panel, which can be structurally reinforced in regions, and cover the back panel with a covering, for example, a fabric cover. A padding material is normally arranged between the back panel and the cover.

It is further known to fasten the covering by means of a seat cover duct, formed on the back panel, to the back panel. The seat cover duct is formed directly into the back panel itself during production of the back panel. Holding means, such as, for example, “J clips”, can then be plugged onto the seat cover duct, which holding means are provided on a boundary of the covering.

Such a backrest is apparent, for example, from the publication DE 10 2008 018 059 A2.

It is disadvantageous in such backrests that the back panel must be deformed at least very significantly and with small radii in order to produce the seat cover duct. As a result of this, the strength of the back panel is significantly impaired. The formation of the seat cover duct in corner regions of the back panel has furthermore been shown to be comparatively difficult.

### DISCLOSURE OF THE INVENTION

One object of the present invention is to provide a backrest with a back plate and a covering to be fastened to the back plate, in the case of which no impairments of strength occur and in the case of which a simple mounting of the covering on the back plate is to be realized simultaneously.

This object is achieved by a seat part, having a seat part plate, a covering and a fastening duct for fastening the covering to the seat part plate, wherein the seat part further has a fastening means fastened separately to the seat part plate and wherein the fastening means has the fastening duct, wherein the seat part comprises a backrest and the seat part plate comprises a back plate of a vehicle seat, wherein the back plate comprises a back panel, wherein the fastening means is fastened with the seat part plate via an adhesive connection, wherein the seat part has at least one corner connector, which, in a corner region of the seat part plate, connects two fastening means, which are arranged at an angle to one another, to one another, wherein the corner connector comprises a plastic part and wherein the corner connector is locked in place to the fastening ducts of the two fastening means, wherein the lengths of the fastening means are formed to be variable.

In the case of the seat part according to the invention, a fastening duct is advantageously provided which enables simple fastening of the covering to the seat part plate and thus ensures a comparatively rapid and low-cost mounting of the covering. In contrast to the prior art, this fastening duct is, however, not formed integrally into the seat part plate so that advantageously no impairments of strength occur in the region of the seat part plate, rather the fastening duct is formed in the fastening means which is fastened as a separate component to the seat part plate. The seat part comprises in particular a backrest and the seat part plate comprises a back plate of the vehicle seat. The back plate, which is typically also referred to as a “backpanel”, comprises in particular a back panel. The seat covering duct can also be referred to as a “trim duct” and the covering as a “trim”. The covering comprises in particular a fabric cover. A back rug of the backrest can advantageously additionally also be fastened to the fastening duct. It is conceivable that the seat part, in an alternative embodiment, comprises the substantially horizontal seat surface of a vehicle seat. As a result of the fastening of the fastening means with the seat part plate via an adhesive connection, simpler and lower cost manufacture is advantageously enabled. As a result of the use of corner connectors, the variable formation of the lengths of the fastening means and the locking in place of the corner connector with the fastening means to the fastening ducts, it is advantageously enabled that the components can be manufactured in accordance with the respective requirements, in particular in various materials and wall thicknesses. The fastening duct is advantageously shaped to be rectilinear in order to simplify the locking in place of the corner connector with the fastening means on the fastening ducts.

According to one preferred embodiment of the present invention, it is provided that the covering comprises a fabric cover. It is conceivable that a padding is arranged between the seat part plate and the covering.

According to a further preferred embodiment of the present invention, it is provided that the seat part has holding means connected to the covering, which holding means can be anchored, in particular locked in place, in the fastening duct. The holding means are arranged in particular along the boundary of the covering. It is preferably provided that the holding means comprise clips, preferably “J clips”.

It is provided that the fastening means is fastened with the seat part plate via an adhesive connection, welded connection, screw connection, rivet connection or the like. The welded connection has nevertheless been shown to be particularly advantageous. It is conceivable that the fastening means has at least one flange which extends parallel to the main extension plane of the seat part plate, which flange is fixedly welded to the seat part plate. A structural reinforcement of the seat part plate is advantageously achieved by the welding of the fastening means onto the seat part plate.

According to a further preferred embodiment of the present invention, it is provided that the fastening means extends as a hollow profile along an edge region of the seat part plate. The fastening means is formed in particular into the fastening means, preferably produced in a roll forming process. The fastening means comprises in particular a rectilinear metal profile. The fastening duct thus advantageously does not have to be formed in corner regions of the seat part plate. The length of the fastening means can be formed variably so that the fastening means can be adapted flexibly to different fastening requirements and to different seat part geometries.

It is provided that the seat part has at least one corner connector which, in a corner region of the seat part plate, connects two fastening means, which are arranged at an angle to one another, to one another. The corner connector advantageously comprises a plastic part, in particular a plastic injection molding, produced in an injection molding process. The corner connector is preferably anchored, preferably locked in place and particularly preferably clipped onto the fastening ducts of the two fastening means.

A further subject matter of the present invention is a vehicle seat, having the seat part according to the invention and in particular the backrest according to the invention.

Further details, features and advantages of the invention will become apparent from the drawings and from the following description of preferred embodiments on the basis of the drawings. The drawings merely illustrate exemplary embodiments of the invention which do not restrict the key concept of the invention.

### BRIEF DESCRIPTION OF THE FIGURES

FIG. 1 shows a schematic view of a seat part according to an exemplary embodiment of the present invention.

FIG. 2 shows a schematic detailed view of the seat part according to the exemplary embodiment of the present invention.

### EMBODIMENT OF THE INVENTION

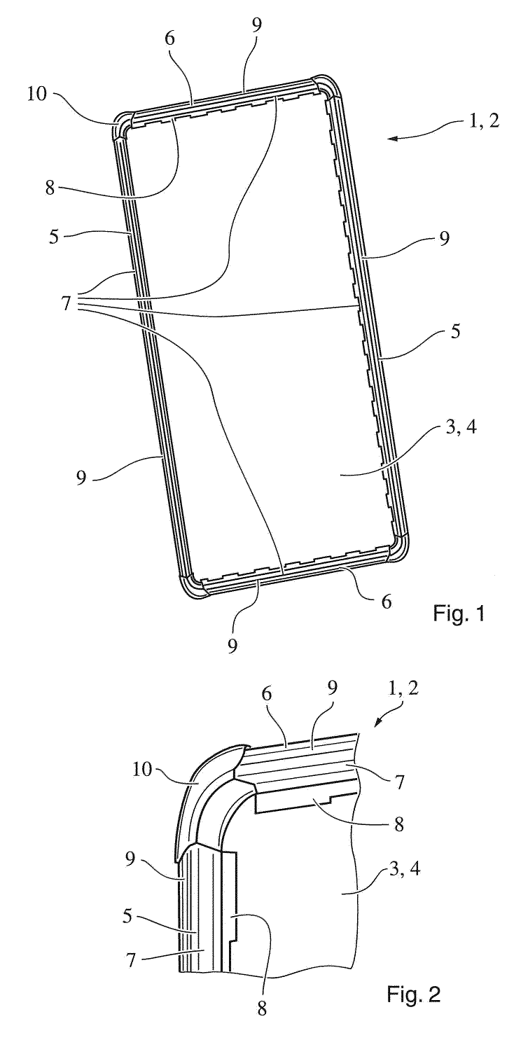

A seat part 1 according to an exemplary embodiment of the present invention is represented schematically in FIGS. 1 and 2, wherein a detailed view of a corner region of seat part 1 shown in FIG. 1 is illustrated in FIG. 2.

In this example, seat part 1 comprises a backrest 2 of a vehicle seat, not shown. Seat part 1 comprises a seat part plate 3 in the form of a back plate 4. Back plate 4 is formed as a panel plate which defines the structure of backrest 2. On longitudinal sides 5 and transverse sides 6 of back plate 4, in each case fastening means 7 are fastened, preferably fixedly glued, or alternatively fixedly welded onto back plate 4. Fastening means 7 are formed in each case as metallic hollow profiles, for example, cap profiles which extend along the rectilinear boundary of back plate 4. Each of the four hollow profiles has several fastening flanges 8 which are parallel to the main extension plane of back plate 4 (see in particular FIG. 2) and which bear in each case against back plate 4 and are connected to back plate 4 via a weld seam. The lengths of fastening means 7 are individually adapted to the respective edge length of back plate 4.

Each of four fastening means 7 is provided with a fastening duct 9. Fastening means 7 are in particular produced in a roll forming process in which fastening duct 9 is formed directly into the hollow profile and is formed in particular to be rectilinear. Fastening duct 9 is formed in each case as a groove, which is formed to be open on one side along a direction perpendicular to the main extension plane of back plate 4, with undercutting. Holding means, not shown, such as, for example, “J clips”, can thus be anchored in the groove and behind the undercut. The holding means are fastened to a covering of backrest 2, wherein the multiplicity of holding means extend in particular along a boundary edge of the covering. The covering, not shown, can thus be fastened via the holding means by simple clipping to backrest 2. A padding is preferably arranged between the covering and back plate 4. It is also conceivable that a back rug, not shown, of backrest 2 is fastened to fastening duct 9.

Two fastening means 7 are always substantially perpendicular to one another in the four corner regions of backrest 2. In order to connect these two fastening means 7 in each corner region, backrest 2 has in each case a corner connector 10 in each corner region. Corner connector 10 comprises a plastic part which is produced in particular in an injection molding process. Corner connector 10 is preferably anchored, preferably locked in place and particularly preferably clipped to adjacent fastening ducts 9 of both fastening means 7.

### LIST OF REFERENCE NUMBERS

1 Seat part
2 Backrest
3 Seat part plate
4 Back plate
5 Longitudinal side
6 Transverse side
7 Fastening means
8 Fastening flange
9 Fastening duct
10 Corner connector

1. A seat part having a seat part plate, a covering and a fastening duct for fastening the covering to the seat part plate, wherein the seat part further has a fastening means fastened separately to the seat part plate and wherein the fastening means has the fastening duct, wherein the seat part comprises a backrest and the seat part plate comprises a back plate of a vehicle seat, wherein the back plate comprises a back panel, wherein the fastening means is fastened with the seat part plate via an adhesive connection, wherein the seat part has at least one corner connector, which, in a corner region of the seat part plate, connects two fastening means, which are arranged at an angle to one another, to one another, wherein the corner connector comprises a plastic part and wherein the corner connector is locked in place to the fastening ducts of the two fastening means, wherein the lengths of the fastening means are formed to be variable.

2. The seat part as claimed in claim 1, wherein the fastening duct is shaped to be rectilinear.

3. The seat part as claimed in claim 1, wherein the covering comprises a fabric cover, wherein a padding is arranged between the seat part plate and the covering.

4. The seat part as claimed in claim 1, wherein the seat part has holding means connected to the covering, which holding means are anchored in the fastening duct.

5. The seat part was claimed in claim 4, wherein the holding means are arranged along a boundary of the covering and wherein the holding means comprise clips.

6. The seat part as claimed in claim 1, wherein the fastening means extends as a hollow profile along an edge region of the seat part plate.

7. The seat part as claimed in claim 1, wherein the fastening duct is formed into the fastening means.

8. The seat part as claimed in claim 1, wherein the fastening means comprises a rectilinear metal profile.

9. The seat part was claimed in claim 1, wherein the corner connector comprises a plastic injection molding.

10. The seat part was claimed in claim 1, wherein the corner connector is clipped to the fastening ducts of the two fastening means.

11. A vehicle seat, having a seat part as claimed in claim 1.

12. The seat part as claimed in claim 4, wherein the holding means are locked in piece in the fastening duct.
